(19) United States
(12) Patent Application Publication
(10) Pub. No.: US 2003/0116369 A1
(43) Pub. Date: Jun. 26, 2003

(54) Drive train for motor vehicles

(75) Inventor: Wolf Boll, Weinstadt (DE)

Correspondence Address: CROWELL & MORING LLP, INTELLECTUAL PROPERTY GROUP, P.O. BOX 14300, WASHINGTON, DC, 20044-4300, US

(73) Assignee: DaimlerChrysler AG.

(21) Appl. No.: 10/314,423

(22) Filed: Dec. 9, 2002

(30) Foreign Application Priority Data
Dec. 7, 2001 (DE) 101 60 267.7

(51) Int. Cl. B60K 6/04; B60K 1/00

(52) U.S. Cl. 180/65.2

(57) ABSTRACT

The invention relates to a drive train for motor vehicles containing an engine output shaft of a travel drive engine, a gearbox which is arranged along a theoretical axial center line axially with respect to the engine output shaft, and an electric machine which has, or can have, a drive connection to the gearbox of the travel drive engine, the electric machine being arranged remotely from the travel drive in the force flux downstream of the gearbox.

This application claims the priority of German Patent Application No. 101 60 267.7-22, filed Dec. 7, 2001, the disclosure of which is expressly incorporated by reference herein.

### BACKGROUND AND SUMMARY OF THE INVENTION

The invention relates to a drive train for motor vehicles.

DE 199 05 366 C2 discloses a crankshaft of an internal combustion engine which can be connected in a torque-transmitting fashion by means of a coupling to a gearbox input shaft which is arranged axially with respect thereto. A torsional oscillation damper is arranged in the drive connection between the crankshaft and the primary part of the coupling. The only electric machine disclosed in the document is an internal rotor in which the rotor is arranged radially inside a stator. The rotor of the electric machine is connected to the crankshaft in a torque-transmitting fashion upstream of the torsional oscillation damper, with respect to the direction of force transmission of the engine of the torsional oscillation damper.

DE 694 18 023 T2 describes a hybrid drive with various possible ways of coupling an electric machine to an internal combustion engine in a vehicle. The electric machine can be arranged downstream of a gearbox which follows from the internal combustion engine.

DE 199 19 452 A1 discloses a hybrid drive in which an electric machine is connected to a gearbox in a positively locking fashion.

An object of the invention is to specify a drive train with an internal combustion engine and an electric machine, wherein the electric machine can be easily integrated into existing conventional drive trains without complex restructuring.

This may be achieved by the invention described hereinafter and defined by the claims.

The advantage of the invention is that the arrangement can be integrated into various types of vehicles without relatively large changes to the drive train. A further advantage of the invention is its suitability for all-wheel-driven vehicles. It is particularly advantageous that existing series-produced gearboxes only need to undergo slight changes to the housing but otherwise normally expensive internal parts can remain the same.

Other objects, advantages and novel features of the present invention will become apparent from the following detailed description of the invention when considered in conjunction with the accompanying drawings.

### BRIEF DESCRIPTION OF THE DRAWINGS

FIG. 1 shows an axial section of a preferred drive train according to the invention, and

FIG. 2 shows an axial section of a preferred arrangement for a vehicle with four-wheel drive.

### DETAILED DESCRIPTION OF THE DRAWINGS

The electric machine can be embodied as a starter for starting an internal combustion engine, as a drive for driving the motor vehicle with or without the internal combustion engine (hybrid drive), and/or as a generator for generating current. The engine output shaft can be the crankshaft of an internal combustion engine or of another engine or motor or a shaft which is arranged downstream of said crankshaft, and can be driven by it. The gearbox drive shaft can be a gearbox input shaft or a shaft of the gearbox which is arranged upstream of the other. A particularly compact design is obtained if it is the gearbox input shaft and the engine output shaft is the crankshaft.

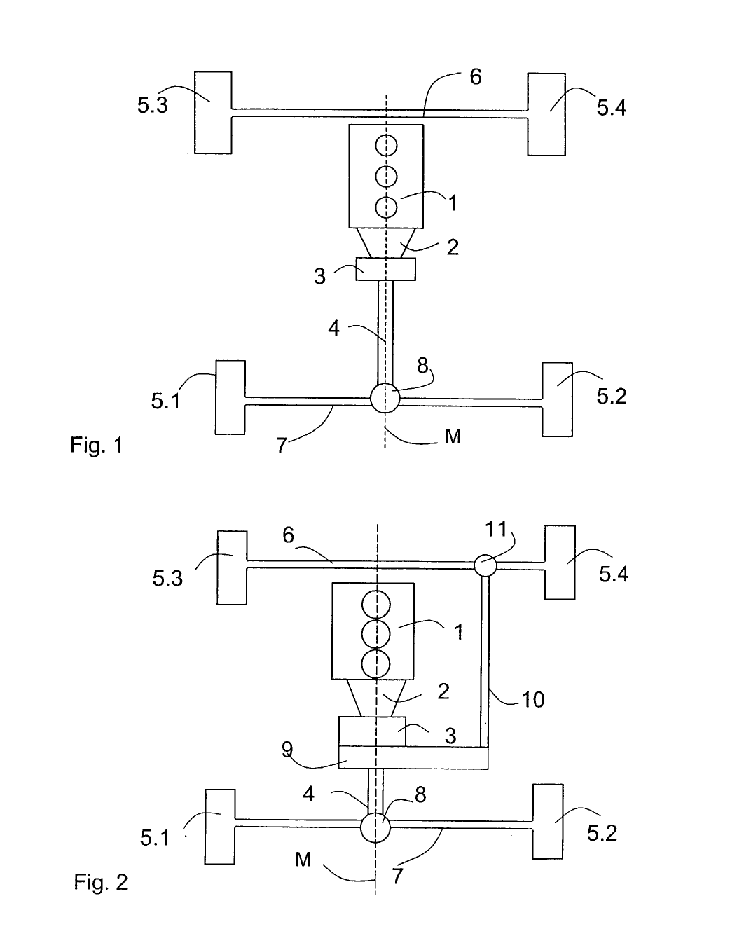

The motor vehicle drive train according to the invention, as shown in FIG. 1, contains an output shaft, preferably a crankshaft of an engine 1, for example an internal combustion engine, and a gearbox 2 which is arranged along a theoretical axial center line M of the engine output shaft. The gearbox 2 is preferably a rear-axle gearbox. The gearbox input shaft is preferably directly connected to the engine output shaft.

The wheels 5.1, 5.2 which are connected to one another by a shaft 7 are driven by the engine 1 and are at least directly connected to it by a differential gear 8, and to the drive shaft 4. The wheels 5.3, 5.4 which are connected to one another via a shaft 6 are represented as non-driven wheels in this exemplary embodiment.

According to the invention, an electric machine 3 is connected to the gearbox output shaft and arranged concentrically around the drive shaft 4. Here, according to the invention, the stator of the electric machine 3 is supported with respect to the gearbox housing 2. The electric machine 3 is preferably connected in a positively locking fashion to the housing 2.

The electric machine 3 can be embodied as an external rotor in which the rotor is arranged radially outside the associated stator. Hence, in comparison with an electric machine with the same external diameter, a larger diameter is obtained for the rotor, this providing a larger torque. However, the electric machine 3 can also be embodied as an internal rotor in which the stator surrounds the rotor concentrically.

The stator of the electric machine 3 is preferably screwed to the gearbox 2 by screws. The screws can extend through a core stack of the stator of the electric machine 3 or be arranged underneath it.

The electric machine 3 can start the engine 1 and/or support it in driving the vehicle. For this purpose, the torque of the electric machine 3 can be transmitted to the engine 1 via the gearbox 2. It is favourable if the electric machine 3 can be decoupled from the drive axle for this purpose. Furthermore, the vehicle can also be driven by the electric machine 3, in particular in regions where no exhaust gas emissions are desired. For this purpose, the gearbox 2 is preferably switched to the idling mode and the torque of the electric machine 3 is transmitted to the drive wheels 5.1, 5.2 via the shaft 4. Furthermore, the, electric machine 3 can be operated as a generator which preferably charges an energy storage device, an accumulator battery by preference. As a generator, the electric machine 3 can also feed braking energy back into the energy storage device.

The advantage of the arrangement is that it is easy to integrate the design into existing conventional drive trains without complex restructuring. The installation space in a drive train is usually very largely utilized so that the addition of further components entails a considerable structural outlay. Likewise, existing components which are already installed in the best possible way are possibly influenced. Therefore, fitting in a further component requires an appreciable degree of financial expenditure. According to the invention, it is possible to use the existing installation space in the Kardan tunnel. To do this, only the length of the Kardan shaft has to be adapted, depending on the overall length of the electric machine. It proves particularly favourable here that the body shell of a series-produced vehicle also remains essentially the same as a result of the packaging according to the invention. The overall costs of a vehicle in which the arrangement according to the invention is used are thus reduced considerably.

An arrangement for an all-wheel-driven variant of the vehicle is given in FIG. 2. Elements which are identical to those in FIG. 1 are provided with identical reference symbols. In the embodiment shown, all four wheels 5.1, 5.2, 5.3, 5.4 are now driven. A transfer transmission 9 is arranged along the theoretical axial center line M, following the electric machine 3 in the axial direction. The transfer transmission 9 transmits torque of the engine 1 and/or of the electric machine 3 to the wheels 5.3, 5.4 via a shaft 10, which acts on the drive wheels on the shaft 6 via a differential gear mechanism 11. The electric machine 3 is preferably connected to the housing of the gearbox 2 and to the housing of the transfer transmission 9 in a positively locking fashion.

In a further preferred refinement, the transfer transmission 9 is arranged between the gearbox 2 and the electric machine 3. The stator of the electric machine 3 is supported on the housing of the transfer transmission 9, and the transfer transmission 9 is connected directly to the gearbox 2 with flanges. The connection between the electric machine 3 and the transfer transmission 9 is preferably positively locking. Which of the two arrangements is selected depends expediently on the packaging of the transfer transmission 9 and on the possible lengths of the Kardan shaft.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed:

1. A drive train for a motor vehicle, comprising:
an output shaft of an engine;
a gearbox which is connected to the engine output shaft; and
an electric machine including a stator which is connected to the gearbox with screws, the screws extending through a core stack of the stator, wherein the electric machine is arranged downstream of the gearbox in terms of power transmission.

2. The drive train according to claim 1, wherein the stator of the electric machine is connected to a housing of the gearbox.

3. The drive train according to claim 1, further comprising a transfer transmission, wherein the electric machine is arranged between the gearbox and the transfer transmission.

4. The drive train according to claim 3, wherein the electric machine is in positively locking contact with the gearbox and the transfer transmission.

5. The drive train according to claim 3, wherein the stator of the electric machine is connected to a housing of the transfer transmission.

6. The drive train according to claim 3, wherein the electric machine includes an internal rotor.

7. The drive train according to claim 1, wherein, to start the engine, the electric machine is connected to the engine in a torque-transmitting fashion and disconnected from a drive axle.

8. The drive train according to claim 1, wherein, when the engine is running, the electric machine is connected in a torque-transmitting fashion to an output shaft of the gearbox.

9. The drive train according to claim 1, wherein the electric machine functions as a generator.

10. The drive train according to claim 1, wherein the electric machine is connected to an energy storage device.

11. A method for making a drive train for a motor vehicle, comprising:
connecting a stator of an electric machine of the drive train to a gearbox of the drive train with screws extending through a core stack of the stator, wherein the electric machine is arranged downstream of the gearbox in terms of power transmission.

12. The method according to claim 11, wherein the step of connecting the stator of the electric machine to the gearbox with the screws including connecting the stator of the electric machine to a housing of the gearbox.

13. The method according to claim 11, further comprising a transfer transmission, wherein the electric machine is arranged between the gearbox and the transfer transmission.

14. The method according to claim 13, further comprising placing the electric machine in positively locking contact with the gearbox and the transfer transmission.

15. The method according to claim 13, further comprising connnecting the stator of the electric machine to a housing of the transfer transmission.

16. The method according to claim 13, wherein the electric machine includes an internal rotor.

17. The method according to claim 11, further comprising, to start the engine, connecting the electric machine to the engine in a torque-transmitting fashion and disconnecting the electric machine from a drive axle.

18. The method according to claim 11, further comprising, when the engine is running, connecting the electric machine in a torque-transmitting fashion to an output shaft of the gearbox.

19. The method according to claim 11, further comprising using the electric machine as a generator.

20. The method according to claim 11, further comprising connecting the electric machine to an energy storage device.
